(19) United States
(12) Patent Application Publication
(10) Pub. No.: US 2014/0360616 A1
(43) Pub. Date: Dec. 11, 2014

(54) REINFORCED FLEXIBLE TUBING AND METHOD OF MAKING SAME

(71) Applicant: CRUSHPROOF TUBING COMPANY, McComb, OH (US)

(72) Inventor: Vance M. Kramer, Jr., Perrysburg, OH (US)

(21) Appl. No.: 14/300,886

(22) Filed: Jun. 10, 2014

Related U.S. Application Data
(60) Provisional application No. 61/833,573, filed on Jun. 11, 2013.

(51) Int. Cl. B29C 53/58; F16L 11/08; B29C 53/62

(52) U.S. Cl. CPC B29C 53/583; B29C 53/62; F16L 11/08
USPC 138/137; 156/144

(57) ABSTRACT

A method for making helically corrugated rubber tubing with a helical reinforcing element secured therein. A helical spring like element with axially spaced convolutions is slid onto a mandrel and a sleeve formed of uncured rubber is slid over the spring like element. The mandrel is then rotated about its axis and a flexible cord is wrapped around the sleeve to press portions of the sleeve into the spaces between adjacent convolutions of the spring like element and form helical corrugations. The resulting assembly is then placed in an oven to cure the rubber sleeve after which the cord is removed. The finished product is then removed from the mandrel.

### BACKGROUND OF THE INVENTION

1. Field of Invention

This invention relates to crush resistant flexible tubing for conveying liquids and gases and, in some cases, dry granular material. The tubing is formed primarily of an elastomeric material that provides a strong but flexible length of tubing. More particularly, the invention relates to tubing that has external helical corrugations formed along its axial length as well as supplemental reinforcement secured therein. The invention also provides a method for making the reinforced tubing.

2. Description of Related Art

Conventionally, flexible tubing with helical corrugations to provide crush resistance has been made using a “cording” method such as is disclosed in U.S. Pat. Nos. 2,832,096; 2,879,953; 2,888,719; 2,909,198; 3,155,757 and 3,635,255; and in Pub. No. US 2013/0037159 A1. The aforementioned patents and published patent application are hereby incorporated by reference in their entirety.

The present invention provides a useful improvement and variation of the type of corrugated tubing that may be made using the “cording” method. The tubing produced in accordance with the present method not only has helical corrugations, but also has a correspondingly shaped helical reinforcing element secured therein along at least a portion of its length.

In the prior art, helically corrugated rubber tubing resulting from the “cording” method has been made by first sliding an extruded sleeve of uncured rubber axially over a rotatable mandrel with a continuous thread formed on its outer surface. When in place on the mandrel, the sleeve is forced into the helical groove or root of the thread by wrapping a length of cord around the sleeve as the sleeve rotates with the mandrel. This serves to impart a desired corrugated shape to the uncured rubber sleeve. The resulting assembly is then removed from its rotary support and placed in an oven or autoclave to cure the rubber sleeve and set the helical corrugations. The cord is removed from the corrugated tubing by placing the assembly back on a rotary support and rotating the mandrel in the reverse direction while unwinding the cord from the cured tube. After removal of the cord, the corrugated tube length may be removed from the mandrel, for example, by introducing air under pressure between the outer surface of the mandrel and the inner surface of the corrugated tube.

The tubular product resulting from this method is both flexible and resilient, but also has sufficient crush resistance to satisfy most applications. Also the tube has a wall that defines continuous internal and external threads with alternating crests and roots along the tube length. In other words, the wall portion that defines a crest portion of the external thread also defines, on its opposite side, the root portion of the internal thread.

A particular limitation as to corrugated rubber tubing made in accordance with the known “cording” method is the degree of crush resistance that can be obtained. While the tubing has sufficient resilience to return to its normal condition when crushed (e.g. when stepped on) there are some applications where greater resistance to crushing or kinking is necessary. One such application is in connection with the exhausting of noxious gases from interior workspaces. If the tubing is inadvertently crushed or collapsed for any period of time a dangerous situation could result.

### BRIEF SUMMARY OF THE INVENTION

The flexible tubing resulting from the present invention is not only provided with helical corrugations but also has a helical reinforcing element securely retained therein. This is accomplished via the use of a variation of the “cording” method described above. In accordance with the invention, a helical spring like reinforcing element with axially spaced convolutions is slid axially over a cylindrical mandrel mounted on a rotatable support. Then an appropriately sized sleeve formed of uncured rubber is slid axially over the helical spring like element. The helical spring like reinforcing element preferably have an inner diameter just slightly larger than the outer diameter of the mandrel so that the element is supported in axial alignment with the mandrel while permitting sliding movement of the reinforcing element on the mandrel surface. Then the mandrel with the reinforcing element and uncured rubber sleeve thereon is rotated about its axis while wrapping a cord about the sleeve to press portions of the sleeve into the spaces between adjacent convolutions of the reinforcing element. This serves to provide internal and external helical ridges and grooves in the uncured rubber sleeve. The resulting assembly with the cord wrapped thereon, and while still positioned on the mandrel, is then heated to cure the sleeve. After the sleeve is cured, the mandrel is rotated about its axis in the reverse direction while the cord is unwrapped and removed. Finally the resulting length of reinforced tubing is slid axially off the mandrel to complete the process.

The reinforcing element is formed to provide appropriate spacing between its helical convolutions to accommodate the cord used in the process. Also the reinforcing element is preferably formed of metal and, because surface portions of the reinforcing element are exposed in the interior of the tubing, stainless steel is particularly appropriate. Preferably, the internal ridges of the resulting length of tubing have a diameter slightly greater than the diameter of the mandrel so that the ridges do not engage the mandrel's cylindrical surface. This facilitates sliding movement of the tube length during its removal from the mandrel.

The foregoing and other features of the invention are hereinafter more fully described and particularly pointed out in the claims, the following description setting forth in detail certain illustrative embodiments of the invention, these being indicative, however, of but a few of the various ways in which the principles of the present invention may be employed.

### BRIEF DESCRIPTION OF THE DRAWINGS

FIGS. 1, 2 and 3 are fragmentary elevations illustrating sequentially, the method for making reinforced corrugated tubing in accordance with the invention, with parts broken away and shown in section.

FIG. 4 is a fragmentary elevation illustrating a length of reinforced corrugated rubber tubing made in accordance with the method of the invention.

### DETAILED DESCRIPTION OF THE INVENTION

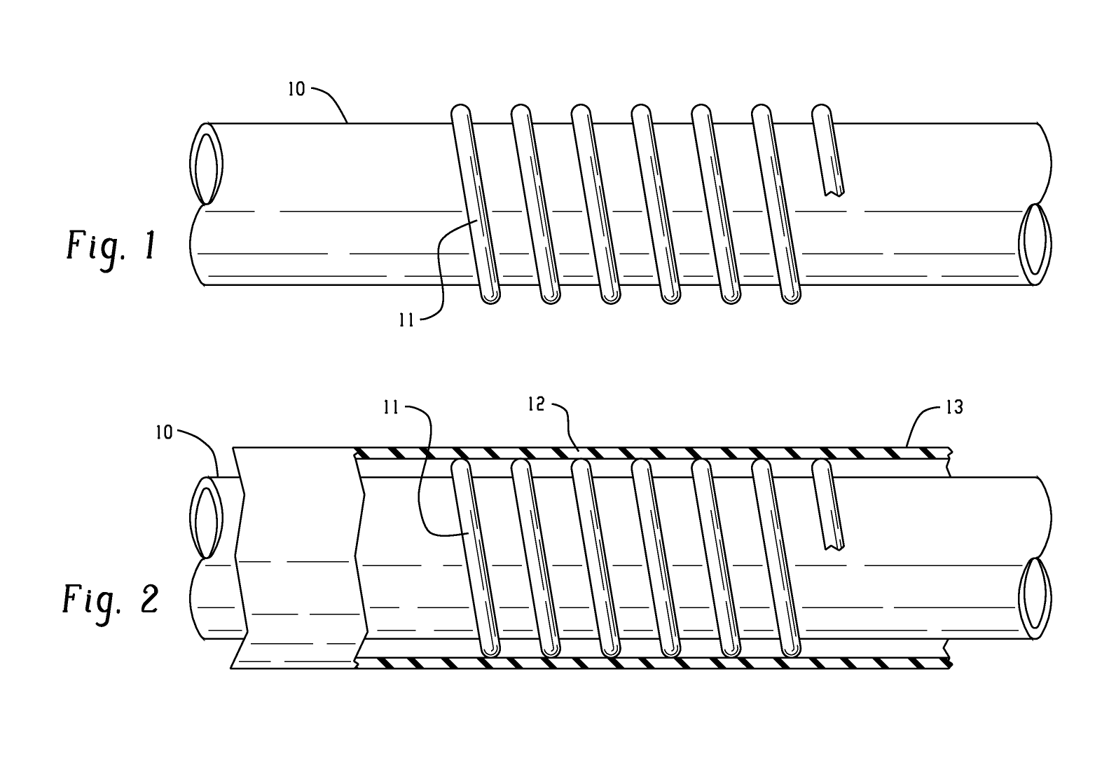

Referring more particularly to the drawings, FIGS. 1, 2 and 3 illustrate sequentially the steps used in practicing the method of the invention. The apparatus used in the process includes a cording mandrel 10 mounted on a rotatable support. In a preferred embodiment, the cording mandrel is cylindrical and is provided with a relatively smooth surface. It will be appreciated, however, that the cording mandrel could alternatively have a cross-section that defines a round shape other than that of a circle (e.g., an oval), provided that a reinforcing element 11 having a corresponding shape is used.

The process is begun by sliding a helical spring like reinforcing element 11, preferable formed of stiff metal such as stainless steel, over the cording mandrel 10 as shown in FIG. 1. It will be understood that the reinforcing element 11 may also be formed of other relatively stiff material (e.g., plastic) depending on the particular application. The convolutions of the helical reinforcing element 11 are axially spaced sufficiently to permit helical corrugations of the desired shape and size to be formed. The inner diameter of the reinforcing element 11 is preferably just slightly larger than the diameter of the cording mandrel 10 so that the reinforcing element is supported in axial alignment with the mandrel while permitting sliding movement of the reinforcing element on the mandrel surface.

An extruded sleeve 12 of uncured rubber is then slid into position over the reinforcing element 11 as shown in FIG. 2. The sleeve 12 may be formed for example of EDPM rubber, nitrile rubber, or other suitable elastomeric material depending on the particular application. The sleeve 12 has opposite end portions 13 that extend axially beyond the opposite ends of the reinforcing element 11 to permit tubular connector fittings to be formed at the ends of the resulting tube length. A variation of the cording process referred to above is then used to form helical corrugations in the uncured rubber sleeve 12. This is accomplished by rotating the cording mandrel 10 as a length of cord 14 is fed to and wrapped progressively around the uncured rubber sleeve 12 to press portions of the sleeve into the spaces between adjacent convolutions of the helical reinforcing element 11. This produces the tubular assembly shown in FIG. 3.

As to the opposite end portions 13 of the tubular sleeve 12, the cord may be wrapped in tight convolutions (i.e. with no spacing between adjacent convolutions) to press the end portions 13 of the sleeve 12 into engagement with the underlying surface of the cording mandrel 11. This serves to preform tubular connector fittings at the opposite ends of the tubing as will be described below. Then the cording mandrel 10 with the “corded” tubular assembly thereon is removed from the rotary support, placed in a curing oven and heated to cure the rubber sleeve 12 and set the corrugations. After curing, the cording mandrel 10 and the tubular assembly are removed from the oven and again placed in the rotary support. Then the cording mandrel 10 is rotated in the reverse direction, and the cord 14 is unwrapped from the assembly. Finally, the cured tubular product is slid axially off the mandrel. This can be accomplished without the need for the use of compressed air, inasmuch as the frictional engagement between the reinforcing element and the cording mandrel can be overcome by a pulling force. Lubricant can be applied to the mandrel before the reinforcing element is slid onto the mandrel to aid in removal of the final tubing product after curing.

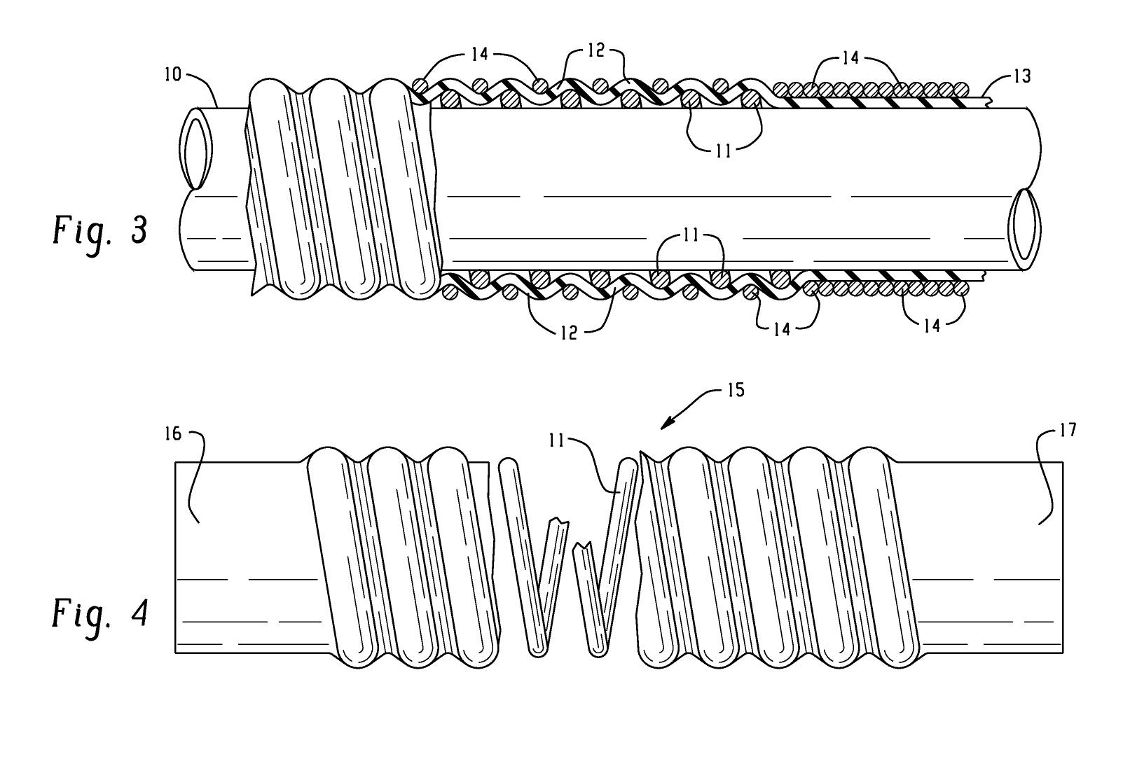

The resulting tubular product 15 is illustrated (in part) in FIG. 4. The product has a tubular connector fitting 16, 17 at each end. The tubular connector fittings serve to lock the helical reinforcing element 11 in the internal root portions of the corrugations by blocking axial movement (i.e. threading movement) of the element 11. This arrangement, together with the cording process, secures the reinforcing element 11 with greater retaining force than could be achieved by inserting a reinforcing element into a helical corrugated hose produced by prior art methods. In fact, it is quite difficult to achieve separation of the cured rubber from the reinforcing element in the tubing product produced by the present invention.

The method of the invention may be used to produce tubing ranging in size from as small as one half inch to as large as 6 inches or more in outer diameter and in lengths from 6 inches to 12 feet. The thickness of the wire used to form the helical spring like element 11 will depend upon its composition, strength and the intended use of the tubing. In a preferred embodiment, the reinforcing element is made of stainless steel wire having a diameter of approximately ¼ inch.

Additional advantages and modifications will readily occur to those skilled in the art. Therefore, the invention in its broader aspects is not limited to the specific details and illustrative examples shown and described herein. Accordingly, various modifications may be made without departing from the spirit or scope of the general inventive concept as defined by the appended claims and their equivalents.

What is claimed is:

1. A method for making a length of flexible, helically corrugated rubber tubing with a helical reinforcing element secured therein, comprising the steps of:
sliding a helical spring like reinforcing element with spaced helical convolutions axially over a cording mandrel;
sliding an uncured rubber sleeve axially over said helical reinforcing element;
rotating said cording mandrel, said reinforcing element and said uncured rubber sleeve about the axis of said mandrel while wrapping a cord about the sleeve to press portions of said sleeve into the spaces between adjacent convolutions of said reinforcing element to form a tubular assembly;
heating said tubular assembly to cure said sleeve;
unwrapping and removing the cord from the cured sleeve; and
sliding the resulting reinforced length of rubber tubing axially from the curing mandrel.

2. A method as defined in claim 1 wherein said helical reinforcing element is formed of stainless steel.

3. A method as defined in claim 1 wherein said helical reinforcing element has an internal diameter so adapted as to locate said reinforcing element in axial alignment with said cording mandrel, while permitting unrestricted sliding movement of said reinforcing element on the surface of said cording mandrel.

4. A method as defined in claim 1 wherein said step of wrapping said cord about said uncured rubber sleeve produces an internal helical ridge in said sleeve, said ridge having an inner diameter that is greater than the diameter of said cording mandrel, whereby said internal helical ridge does not contact the surface of said cording mandrel.

5. A method as defined in claim 1 wherein said uncured rubber sleeve has at least one end portion that extends axially beyond a respective end of said helical reinforcing element.

6. A method as defined in claim 5 wherein said step of wrapping said cord around said uncured rubber sleeve includes wrapping said cord about one of said end portions in tight convolutions with adjacent convolutions of said cord engaging one another to press said end portion inwardly into engagement with the surface of said cording mandrel so as to form a tubular end connector fitting for said length of tubing when said sleeve is cured.

7. The method according to claim 1, wherein said cord is unwrapped and removed from the cured sleeve by rotating said cording mandrel with said tubular assembly thereon about its axis in the reverse direction while unwrapping and removing the cord.

8. The method according to claim 1, wherein a cross-section of the cording mandrel orthogonal to the axis is non-circular.

9. The method according to claim 1, wherein no compressed air is used to remove the resulting reinforced length of rubber tubing from the curing mandrel.

10. A length of reinforced helically corrugated rubber tubing made in accordance with the method of claim 1.
